(19) United States
(12) Patent Application Publication
(10) Pub. No.: US 2023/0098568 A1
(43) Pub. Date: Mar. 30, 2023

(54) COMMUNICATION SYSTEM FOR CHARGER AND ELECTRIC VEHICLE AND RELATED METHOD THEREOF

(71) Applicant: Shenzhen ONE Energy Technology Co., LTD, Shenzhen (CN)

(72) Inventors: Xiaoming Gong, Shenzhen (CN); Liang Wu, Shenzhen (CN); Zhicheng Wei, Shenzhen (CN); Jin Yang, Shenzhen (CN); Liang Tan, Shenzhen (CN)

(21) Appl. No.: 17/722,588

(22) Filed: Apr. 18, 2022

(30) Foreign Application Priority Data
Sep. 26, 2021 (CN) 202111128294.2

(51) Int. Cl. B60L 53/66; G06K 19/06; B60L 53/62; B60L 53/65

(52) U.S. Cl. CPC B60L 53/665; G06K 19/06037; B60L 53/62; B60L 53/65

(57) ABSTRACT

The disclosure discloses a communication system and method for a charger and an electric vehicle. The communication system includes a battery system, a 2-dimensional bar code generating module and a charging and detecting module disposed on the electric vehicle. The communication system further includes a power module, a 2-dimensional bar code identifying module, a start button and a discharging module disposed on the charger. The 2-dimensional bar code generating module is connected to the battery system for obtaining the internal information of electric vehicles, which is displayed in a form of 2-dimensional bar code images. The 2-dimensional bar code identifying module is connected to the power module for realizing scanning, recognition and payment functions. The power module includes a discharge microcontroller and a discharge circuit, which is used to charge electric vehicles and adjust charging strategies according to 2-dimensional bar code images. In addition, the 2-dimensional bar code identifying module can scan the 2-dimensional bar codes to generate the 2-dimensional bar code images, and the charging and detecting module is connected to the discharging module through the a charging line. Not only the communication line is omitted, but also the charging operation process is accurate, simple and convenient to achieve a good user experience.

### CROSS-REFERENCE TO RELATED APPLICATIONS

This application claims a priority of the following Chinese Patent Application: CN 202111128294.2 filed on Sep. 26, 2021, the disclosures of which are incorporated herein in their entirety by reference.

### BACKGROUND

### Technical Field

The disclosure relates to a communication system and a communication method, in particular to a charging and a discharging communication system for a charger and an electric vehicle and a related communication method thereof.

### Related Art

At present, electric vehicles have become an important direction of automobile development. With the increase of the number of electric vehicles, charging piles for electric vehicles need to be installed in each area. The internal power system of electric vehicles are battery systems, and the charging characteristics of batteries need different types of charging according to the working conditions of batteries. For example, the energy storage size and battery type of each type of electric vehicle are inconsistent, and manufacturers are also inconsistent. In addition, the charger needs to be charged according to the current state of the car battery, so the communication between the car and the charger needs to be carried out. The common communication methods include CAN, RS485 and RS232 etc.

In the existing technology, the charger is charged to the vehicle by fixed charging parts. There are two kinds of charging means of the charging parts, such as a direct current charging means and an alternating current charging means. Communication lines and charging power lines are set on a same charging part. However, if RS485 or RS232 communication mode is adopted, redundant connection lines are required. If the communication mode is power carrier communication, because the power carrier transmits information on the power line, the interference will be stronger.

Therefore, a new communication system used between a charger and an electric vehicle is urgently needed.

### SUMMARY

In view of the above existing technical problems, the disclosure provides a communication system for a charger and an electric vehicle and a communication method thereof. The charger realizes the technical purpose of strategic charging of the vehicle by identifying the content of the 2-dimensional bar code on the electric vehicle.

In order to realize the above purposes, the present disclosure provides a communication system used between a charger and an electric vehicle.

The communication system comprises a battery system, a 2-dimensional bar code generating module and a charging and detecting module which are disposed on the electric vehicle.

The communication system further comprises and a power module, a 2-dimensional bar code identifying module, a start button and a discharging module which are disposed on the charger.

The battery system is used for providing electric power to the electric vehicle.

The 2-dimensional bar code generating module is connected with the battery system for obtaining the internal information of the electric vehicle to display in a form of 2-dimensional bar code images.

The charging and detecting module is connected with the battery system and the 2-dimensional bar code generating module, respectively.

In this embodiment of the present disclosure, the charging and detecting module connected with the battery system and the 2-dimensional bar code generating module comprises a detecting module, a charging module and a first microcontroller unit (MCU).

The detecting module is used for detecting usage status whether the charger is inserted into the charging and detecting module, and transmitting the usage status information to the 2-dimensional bar code generating module.

The charging module is connected with the battery system for the charger to be inserted into, so as to charge the battery system of the electric vehicle.

The 2-dimensional bar code identifying module is used for scanning the 2-dimensional bar code images generated by the 2-dimensional bar code generating module to realize scanning, identifying and payment functions

The power module, disposed on the charger and connected with the 2-dimensional bar code identifying module, comprises a second MCU and a discharging circuit for charging the electric vehicle and adjusting charging status according to the 2-dimensional bar code images

The start button, disposed on the charger and connected with the power module, is used for controlling the on/off of the charger

The discharging module connected with the power module is used for charging the electric vehicle through the charging module of the electric vehicle by a charging cable.

Preferably, the 2-dimensional bar code generating module comprises a third MCU and a display module connected with the third MCU.

The display module comprises a display disposed outside the electric vehicle for displaying charging information of the battery system and the usage status information of the electric vehicle of the electric vehicle in the form of 2-dimensional bar code images.

The third MCU is connected with the battery system for obtaining the charging information of the battery system and the usage status information of the electric vehicle, and controlling display contents of the display module.

Preferably, the detecting module comprises a switch S1 and a resistor R1. The 3.3V power supply end of the battery system is connected to the pin of the third MCU through the resistor R1, which is grounded by the switch S1.

Preferably, the 2-dimensional bar code identifying module comprises a camera module, which is used to scan 2-dimensional bar code, face recognition, license plate recognition and payment functions.

Preferably, the start button comprises button switch S2 and a resistor R2. The 3.3V power supply end of the charger is connected to the pin of the second MCU through the resistor R2 which is grounded by the button switch S2.

In order to realize the above purposes, the present disclosure further provides a communication method of the communication system used between a charger and an electric vehicle. The workflow of the electric vehicle comprises the following steps:

A1: the detecting module of the electric vehicle judging whether there is an external charging device inserted into the charging and detecting module;

A2: if yes, the internal information of the electric vehicle being transmitted to the 2-dimensional bar code generating module by the battery system which will be displayed in the form of 2-dimensional bar code images;

if not, returning to the step A1;

A3: the battery system judging whether the electric power is fully charged;

A4: if yes, the battery system setting a charging demand of the electric vehicle to 0, and returning to the step A1;

if not, the battery system setting the charging demand of the electric vehicle to 1, the 2-dimensional bar code generating module refreshing and displaying the internal information of the electric vehicle provided by the battery system, and refreshing time according to the charging demand; and

A5: returning to the step A1.

Further, the workflow of the charger comprises the following steps:

B1: the 2-dimensional bar code identifying module of the charger judging whether the start button is pressed;

B2: if yes, starting the 2-dimensional bar code identifying module to scan the 2-dimensional bar code images on the electric vehicle;

if not, returning to the step B1;

B3: the 2-dimensional bar code identifying module judging whether the scanned 2-dimensional bar code images are correct;

B4: if yes, the 2-dimensional bar code identifying module reading the internal information of the electric vehicle provided by the 2-dimensional bar code images and transmitting the information to the power module for processing;

if not, returning to the step B3;

B5: the power module judging whether the charging demand is 1;

B6: if yes, the power module adjusting the charging status to charge the electric vehicle according to the internal information of the electric vehicle, and then returning to the step B3;

if not, stopping charging to the electric vehicle and returning to the step B3.

Preferably, the workflow of the charger further comprises the following charging sequence:

In the step B3, to judge whether the scanned 2-dimensional bar code images are scanned correctly by the 2-dimensional bar code identifying module and a timer of the 2-dimensional bar code identifying module is started at the same time.

In the step B4, if yes, the 2-dimensional bar code identifying module reading the information provided by the 2-dimensional bar code images, and transmitting the data to the power module for processing, and resetting the timer at the same time; and

if not, judging whether the timer is reset to zero by the 2-dimensional bar code identifying module;

if yes, turning off the charger; and

if not, returning to the step B3.

Compared with the prior art, the disclosure has the following advantages:

1. As the display of the 2-dimensional bar code generating module is refreshed the information at a certain frequency, the present disclosure mainly uses the carrier of the screen light to communicate between the charging vehicle and the charger.

2. The communication system of the present disclosure utilizes the 2-dimensional bar code communication mode between the electric vehicle and the charger, which not only eliminates the connection of communication line, but also can be applied to wired charging and wireless charging occasions. The 2-dimensional bar code is achieved self-charging, convenient car charging, and is conducive to people's use.

3. The communication system of the present disclosure has a 2-dimensional bar code generating module and a 2-dimensional bar code identifying module. The charger can obtain the internal information of the electric vehicle in real time through the 2-dimensional bar codes, so as to charge the electric vehicle and achieve fast charging match.

4. The communication system of the present disclosure enables the charger to adjust the charging status according to the internal information of the electric vehicle contained in the 2-dimensional bar code images, and the charging operation process is accurate, simple and convenient to achieve good user experience.

### BRIEF DESCRIPTION OF THE DRAWINGS

In order to more clearly explain the embodiment of the present disclosure or the technical scheme in the prior art, the following will briefly introduce the attached drawings that need to be used in the embodiment. It is obvious that the attached drawings in the following description are only some embodiments of the present disclosure. For ordinary technicians in the art, without paying creative labor, other drawings can also be obtained from these drawings.

FIG. 1 illustrates an electrical block diagram of the communication system of the present disclosure.

FIG. 2 illustrates an electrical principle diagram of the 2-dimensional bar code generating module of the communication system of the present disclosure.

FIG. 3 illustrates a 2-dimensional bar code information diagram of the communication system of the present disclosure.

FIG. 4 illustrates an electrical principle diagram of the detecting module of the communication system of the present disclosure.

FIG. 5 illustrates an electrical schematic block diagram of a start button of the communication system of the present disclosure.

FIG. 6 illustrates a working flow chart of an electric vehicle of the communication method of the present disclosure.

FIG. 7 illustrates a working flow chart of a charger of the communication method of the present disclosure.

FIG. 8 illustrates a charging time sequence flow chart of the charger of the communication method of the present disclosure.

### DETAILED DESCRIPTION

In order to make the purpose, technical scheme and advantages of the application more clear, the disclosure is further explained in detail in combination with the attached drawings and embodiments. It should be understood that embodiments described herein are intended only to explain and not to qualify the disclosure.

Unless otherwise defined, all technical and scientific terms used herein have the same meaning as those normally understood by technicians in the technical area of the application. The terms used herein in the specification of this application are intended only to describe specific embodiments and are not intended to limit this application.

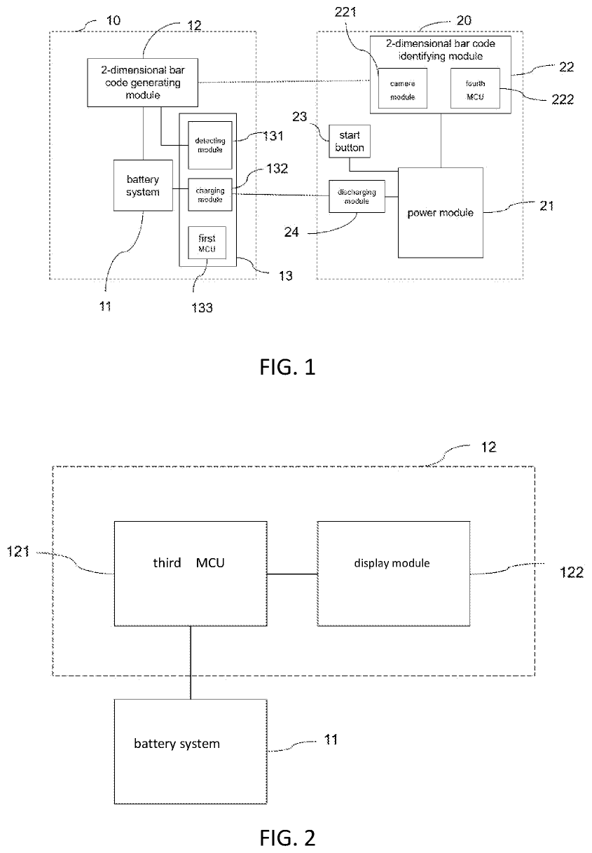

Refer to FIG. 1. FIG. 1 illustrates an electrical block diagram of the communication system of the present disclosure. As shown in FIG. 1, the communication system of the present disclosure is used for the charging process between an electric vehicle 10 and a charger 20.

The electric vehicle 10 comprises a battery system 11, a 2-dimensional bar code generating module 12 and a charging and detecting module 13.

The battery system 11, having a battery management system and a battery cell (not shown), is used for providing electric power to electric vehicle 10.

The 2-dimensional bar code generating module 12 is connected with the battery system 11 for obtaining internal information of the electric vehicle 10, which is displayed in a form of 2-dimensional bar code images.

Please refer to FIG. 2. FIG. 2 is a functional block diagram of the 2-dimensional bar code generating module in the communication system of the present disclosure. As shown in FIG. 2, the 2-dimensional bar code generating module 12 comprises a third microcontroller Unit (MCU) 121 and a display module 122. The display module 122 is connected with the third MCU 121. The MCU 121 is connected with the battery system 11 for obtaining the internal information of the battery system 11 and the usage status information of the electric vehicle, and controlling display contents of the display module 122 in the form of 2-dimensional bar code images. The display module 122 has a display (not shown), which is used to display the internal information of electric vehicle 10 in the form of 2-dimensional bar code images.

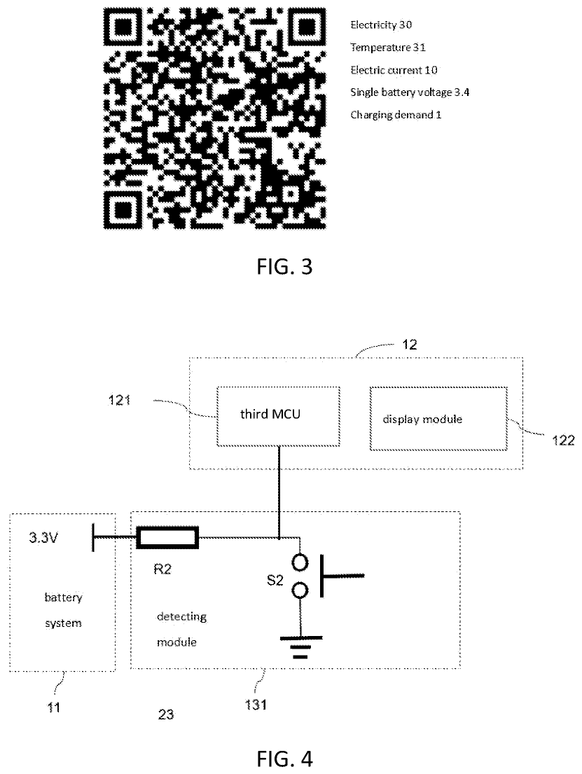

During implementation, the battery system 11 of the electric vehicle 10 can communicate with the third MCU 121 of the 2-dimensional bar code generating module 12 through communication line, and then generate internal information of the electric vehicle 10 into 2-dimensional bar codes . The display of the display module 122 is used for displaying the internal information of the electric vehicle 10 which comprises the battery voltage, electric quantity and temperature of the electric vehicle 10. In some embodiments, as shown in FIG. 3, the 2-dimensional bar code images displayed on the display stores the information of electric quantity 30, temperature 31, current 10, monomer voltage 3.4 and a charging demand 1.

As shown in FIG. 1, the charging and detecting module 13 includes a detecting module 131, a charging module 132 and a first microcontroller unit (MCU) 133. The detecting module 131 is used for detecting usage status whether the charger 20 is inserted into the charging and detecting module 13, and transmitting the usage status information to the 2-dimensional bar code generating module 12. As shown in FIG. 4, the detecting module 131 includes a switch S1 and a resistor R1. The 3.3V power supply end of battery system 11 is connected to the pin of the third MCU 121 through the resistor R1, which is grounded by the switch S1. In some embodiments, the charging and detecting module 13 can be a charging socket on the electric vehicle 10.

During the implementation, when the switch Si of detecting module 131 of the charging and detecting module 13 is started, the level of the pin of the third MCU 121 is pulled down and the charger 20 is detected to be inserted into charging and detecting module 13 to light up the display of the display module 122. Meanwhile, the first MCU 133 of the charging and detecting module 13 identifies the external charger 20 inserting into the charging and detecting module 13 and informs the battery system 11 to transmit the internal information of the battery system 11 and the usage status information of the electric vehicle 10 to the third MCU 121 of the 2-dimensional bar code generating module 12. Then the third MCU 121 of the 2-dimensional bar code generating module 12 will display the internal information of the battery system 11 and the usage status information of the electric vehicle 10 in the form of 2-dimensional bar code images on the display of the display module 122. When the external charger 20 pulls out from the charging and detecting module 13, the switch Si springs up, and the pin of the third MCU 121 121 restores to high level. When the third MCU 121 detects that the charger 20 pulls out from the charging and detecting module 13, the third MCU 121 waits for a certain period of time before turning off the display.

As shown in FIG. 1, as a charging equipment, the charger 20 comprises a power module 21, a 2-dimensional bar code identifying module 22, a start button 23 and a discharging module 24.

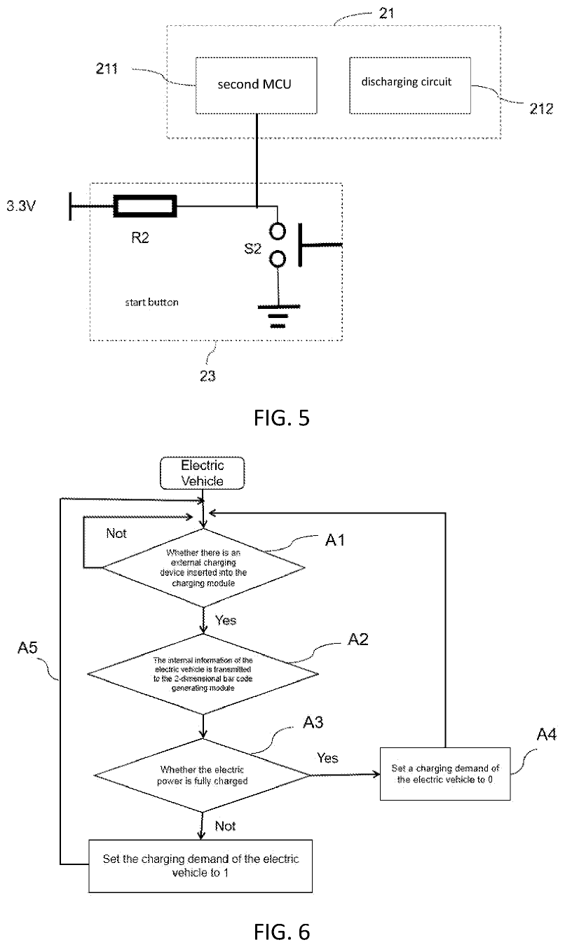

The start button 23 is connected with the power module 21 for controlling the on/off of the charger 20. As shown in FIG. 5, the start button 23 includes a button S2 and a resistor R2. The 3.3V power supply end of the charger 20 is connected to the pin of a second MCU 211 of the power module 21 through resistor R2 which is grounded by the button switch S2. Press the start button S2, the charger 20 will start working.

In some embodiments, the discharging module 24 can be a discharge socket on the charger 20, which is connected to power module 21 for charging the electric vehicle 10 through the charging module 132 of the electric vehicle 10 by a charging cable.

The power module 21 includes a second MCU 211 and a discharge circuit 212 for charging the electric vehicle 10 at constant voltage and constant current and adjusting charging status according to the 2-dimensional bar code images of the internal information of the electric vehicle 10 displayed on the display module 122.

The 2-dimensional bar code identifying module 22 is connected with power module 21 for scanning the 2-dimensional bar code images generated by the 2-dimensional bar code generating module 12 to realize scanning, identifying and payment functions. In addition, the 2-dimensional bar code identifying module 22 includes a camera module 221 and a fourth MCU, which can scan and identify the 2-dimensional bar codes of the 2-dimensional bar code generating module 12 to generate the 2-dimensional bar code images, so as to refresh the information stored in the 2-dimensional bar code images, such as the voltage, current, electric quantity and temperature of the battery. The information transmitted to power module 21 is in the form of 2-dimensional bar codes to realize scanning 2-dimensional bar code, face recognition, license plate recognition, scanning code payment and other functions.

When implemented, after the start button 23 is pressed, the charger 20 starts to work. The second MCU 211 of the power module 21 detects that the charge 20 is start, and then starts the 2-dimensional bar code identifying module 22. The 2-dimensional bar code identifying module 22 determines whether the correct 2-dimensional bar code images are detected. If the 2-dimensional bar code identifying module 22 does not detect 2-dimensional bar code images generated by 2-dimensional bar code generating module 12, the charger 20 will automatically shutdown over a period of time. If the 2-dimensional bar code identifying module 22 detects the 2-dimensional bar code images generated by the 2-dimensional bar code generating module 12, the power module 21 starts to charge the electric vehicle 10 through discharging module 24.

In this embodiment, as shown in FIG. 6, the charging workflow of the electric vehicle 10 includes the following steps.

A1: the detecting module 131 of the electric vehicle 10 judges whether there is an external charging device inserted into the charging module 132 of the charging and detecting module 13.

A2: if yes, the internal information of the electric vehicle 10 is transmitted to the 2-dimensional bar code generating module 12 by the battery system 11 which will be displayed in a form of 2-dimensional bar code images. As shown in FIG. 3, the internal information of the 2-dimensional bar codes includes electric quantity 30, temperature of 31, current 10, cell voltage 3.4 and an error tolerance rate 30%. The coding method is QR code.

if not, return to the step A1.

A3: the battery system 11 judges whether the electric power is fully charged.

A4: if yes, the battery system 11 sets a charging demand of the electric vehicle 10 to 0, and then returns to the step A1.

if not, the battery system 11 sets the charging demand of the electric vehicle 10 to 1, the 2-dimensional bar code generating module 12 refreshes and displays the internal information of the electric vehicle 10 provided by the battery system 11, and refreshes time according to the charging demand. In some embodiments, the refresh speed does not need to be too fast, and the refresh speed is set as 1 Hz.

A5: return to the step A1.

It needs to be noted that when the detecting module 131 detects that an external charging device is inserted into the charging and detecting module 13, the 2-dimensional bar code identifying module 22 starts to work and reads the electric quantity of battery system 11 of the electric vehicle 10. When the electric quantity is full, the electric vehicle 10 will not be charged if there is no demand When the battery is low, the electric vehicle 10 keeps being charged and updates the 2-dimensional bar code display data on the display of the display module 122.

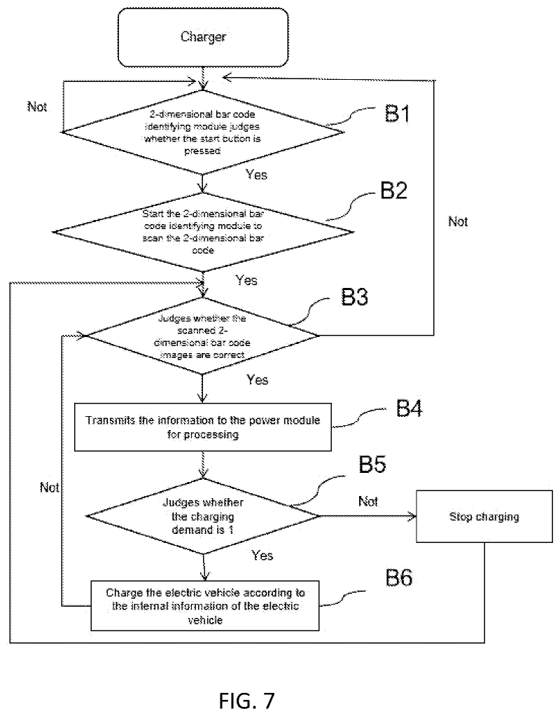

As shown in FIG. 7, the charging workflow of the charger 20 includes the following steps.

B1: the 2-dimensional bar code identifying module 22 of the charger 20 judges whether the start button 23 is pressed.

B2. if yes, start the 2-dimensional bar code identifying module 22 to scan the 2-dimensional bar code images on the electric vehicle 10.

if not, return to the step B1.

B3. the 2-dimensional bar code identifying module 22 judges whether the scanned 2-dimensional bar code images are correct.

B4. if yes, the 2-dimensional bar code identifying module 22 reads the internal information of the electric vehicle 10 provided by the 2-dimensional bar code images and transmits the information to the power module 21 for processing.

if not, return to the step B3.

B5. the power module 21 judges whether the charging demand is 1.

B6. if yes, the power module 21 adjusts the charging status to charge the electric vehicle 10 according to the internal information of the electric vehicle 10, and then return to the step B3.

if not, stop charging to the electric vehicle 10 and return to the step B3. It needs to be noted that when the start button 23 is pressed, the 2-dimensional bar code identifying module 22 will be started. Once the 2-dimensional bar code identifying module 22 recognizes the 2-dimensional bar code display data on the display of the display module 122, the power module 21 recognizes the current internal information of the electric vehicle 10 by scanning 2-dimensional bar code images and adjusting charging status.

If the charging demand of the electric vehicle 10 is 1, the charger 20 will charge the electric vehicle 10; and if the charging demand of the electric vehicle 10 is 0, the charger 20 will not charge. In some embodiments, charging process according to the status of the battery system 11 can be a common three-stage charging strategy for battery system 11. When the electric power of the battery system 11 is very low, trickle charging mode is used; when the power is low, constant current charging strategy is used; and when the electric quantity reaches the set voltage value, it can be charged by constant voltage, or it can be charged by floating charge when the constant voltage charging current is very small.

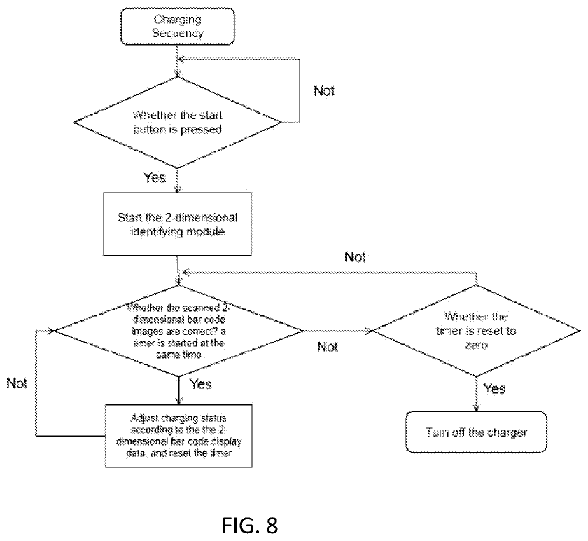

In some embodiments, as shown in FIG. 8, the charging workflow of the charger 20 further includes the following charging sequence.

In the step B3, to judge whether the scanned 2-dimensional bar code images are scanned correctly by the 2-dimensional bar code identifying module 22 and a timer of the 2-dimensional bar code identifying module 22 is started at the same time.

In the step B4, if yes, the 2-dimensional bar code identifying module 22 reads the information provided by the 2-dimensional bar code images, and transmits the data to the power module 21 for processing, and resets the timer at the same time.

If not, to judge whether the timer is reset to zero by the 2-dimensional bar code identifying module 22. If yes, turn off the charger 20; and if not, return to the step B3.

It needs to be noted that when the 2-dimensional bar code identifying module 22 recognizes the 2-dimensional bar code display data on the display of the display module 122, the power module 21 recognizes the current internal information of the electric vehicle 10 by scanning 2-dimensional bar code images and adjusting charging status, and resets the timer of the 2-dimensional bar code identifying module 22. If the 2-dimensional bar code identifying module 22 still does not recognize the 2-dimensional bar code display data on the display of the display module 122 until the timer countdown goes to zero, the charger 20 will be shut down.

Only when the 2-dimensional bar code identifying module 22 recognizes the 2-dimensional bar code display data on the display of the display module 122, the charger 20 will reset the timer of the 2-dimensional bar code identifying module 22 and make the timer not go to zero.

For example, the timer starts to count down from 100, and when it counts down to 96, the 2-dimensional bar code identifying module 22 recognizes the 2-dimensional bar codes, and then starts to count down again from 100. If the 2-dimensional bar code identifying module 22 still does not recognize the 2-dimensional bar codes when it counts down to 0, the charger 20 will be shut down.

It should be noted that the present disclosure is not limited to the above embodiments. According to the creative spirit of the present disclosure, those skilled in the art can also make other modifications, which should not be interpreted as limiting the scope of the present disclosure. It should be noted that all modifications and substitutions equivalent to the embodiment should be included in the scope of the present disclosure. Therefore, the scope of protection of the present disclosure shall be subject to the scope defined in the claims.

What is claimed is:

1. A communication system used between a charger and an electric vehicle, comprising:
a battery system disposed on the electric vehicle for providing eletcric power to the electric vehicle;
a 2-dimensional bar code generating module disposed on the electric vehicle and connected with the battery system for obtaining internal information of the electric vehicle to display in a form of 2-dimensional bar code images;
a charging and detecting module, disposed on the electric vehicle and connected with the battery system and the 2-dimensional bar code generating module, comprising:
a first microcontroller unit (MCU);
a detecting module used for detecting usage status whether the charger is inserted into the charging and detecting module, and transmitting the usage status information to the 2-dimensional bar code generating module; and
a charging module connected with the battery system for the charger to be inserted into, so as to charge the battery system of the electric vehicle;
a 2-dimensional bar code identifying module disposed on the charger for scanning the 2-dimensional bar code images generated by the 2-dimensional bar code generating module to realize scanning, identifying and payment functions;
a power module, disposed on the charger and connected with the 2-dimensional bar code identifying module, having a second MCU and a discharging circuit, for charging the electric vehicle and adjusting charging status according to the 2-dimensional bar code images;
a start button, disposed on the charger and connected with the power module, for controlling the on/off of the charger; and
a discharging module connected with the power module for charging the electric vehicle through the charging module of the electric vehicle by a charging cable.

2. The communication system of claim 1, wherein the 2-dimensional bar code generating module comprises:
a display module comprises a display disposed outside the electric vehicle for displaying charging information of the battery system and the usage status information of the electric vehicle of the electric vehicle in the form of 2-dimensional bar code images; and
a third MCU connected with the battery system for obtaining the charging information of the battery system and the usage status information of the electric vehicle, and controlling display contents of the display module.

3. The communication system of claim 2, wherein the detecting module comprises a switch S1 and a resistor R1, and a power supply end of the battery system is connected to the pin of the third MCU through the resistor R1, which is grounded by the switch S1.

4. The communication system of claim 1, wherein the 2-dimensional bar code identifying module comprises a camera module for scanning 2-dimensional bar codes, face recognition, license plate recognition and payment functions.

5. The communication system of claim 1, wherein the start button comprises a button switch S2 and a resistor R2, and a power supply end of the charger is connected to the pin of the second MCU through the resistor R2 which is grounded by the button switch S2.

6. A communication method of the communication system used between a charger and an electric vehicle of claims 1, wherein the workflow of the electric vehicle comprises the following steps:
A1: the detecting module of the electric vehicle judging whether there is an external charging device inserted into the charging and detecting module;
A2: if yes, the internal information of the electric vehicle being transmitted to the 2-dimensional bar code generating module by the battery system which will be displayed in the form of 2-dimensional bar code images;
if not, returning to the step A1;
A3: the battery system judging whether the electric power is fully charged;
A4: if yes, the battery system setting a charging demand of the electric vehicle to 0, and returning to the step A1;
if not, the battery system setting the charging demand of the electric vehicle to 1, the 2-dimensional bar code generating module refreshing and displaying the internal information of the electric vehicle provided by the battery system, and refreshing time according to the charging demand; and
A5: returning to the step A1.

7. The communication method of claim 6, wherein the workflow of the charger comprises the following steps:
B1: the 2-dimensional bar code identifying module of the charger judging whether the start button is pressed;
B2: if yes, starting the 2-dimensional bar code identifying module to scan the 2-dimensional bar code images on the electric vehicle;
if not, returning to the step B1;
B3: the 2-dimensional bar code identifying module judging whether the scanned 2-dimensional bar code images are correct;
B4: if yes, the 2-dimensional bar code identifying module reading the internal information of the electric vehicle provided by the 2-dimensional bar code images and transmitting the information to the power module for processing;
if not, returning to the step B3;
B5: the power module judging whether the charging demand is 1;
B6: if yes, the power module adjusting the charging status to charge the electric vehicle according to the internal information of the electric vehicle, and then returning to the step B3;
if not, stopping charging to the electric vehicle and returning to the step B3.

8. The communication method of claim 7, wherein the workflow of the charger further comprises the following charging sequence:
In the step B3, to judge whether the scanned 2-dimensional bar code images are scanned correctly by the 2-dimensional bar code identifying module and a timer of the 2-dimensional bar code identifying module is started at the same time;
In the step B4, if yes, the 2-dimensional bar code identifying module reading the information provided by the 2-dimensional bar code images, and transmitting the data to the power module for processing, and resetting the timer at the same time; and
if not, judging whether the timer is reset to zero by the 2-dimensional bar code identifying module;
if yes, turning off the charger; and
if not, returning to the step B3.
